(19) United States
(12) Patent Application Publication
(10) Pub. No.: US 2003/0174210 A1
(43) Pub. Date: Sep. 18, 2003

(54) Video surveillance method, video surveillance system and camera application module

(75) Inventors: Markku Vimpari, Oulu (FI); Sami Mikkonen, Oulu (FI)

Correspondence Address: CRAWFORD MAUNU PLLC, Suite 390, 1270 Northland Drive, St. Paul, MN, 55120, US

(73) Assignee: Nokia Corporation

(21) Appl. No.: 10/378,978

(22) Filed: Mar. 3, 2003

(30) Foreign Application Priority Data
Mar. 4, 2002 (FI) 20020413

(51) Int. Cl. H04N 7/18

(52) U.S. Cl. 348/152; 348/156; 348/700

(57) ABSTRACT

A video surveillance system comprises means (700, 800, 900) for monitoring a space under surveillance, the system comprises means (700, 800, 900, 702, 704, 706) for transmitting an alarm message over the radio path to at least one user terminal (170, 908), the system comprises means (702, 802, 902, 1100) for taking a pre-determined number of pictures at pre-determined intervals and the system comprises means (702, 802, 902, 1100) for transmitting pictures that have been processed as required by the transmission method over the radio path to a connecting device and the system comprises means (704, 804, 904) for further transmitting pictures that have been re-processed as required by the transmission method, if necessary, over the radio path to at least one user terminal (170, 908).

### FIELD

The invention relates to a video surveillance method, a video surveillance system and a camera application module, which function in a radio telecommunications system.

### BACKGROUND

Various burglar alarm and video surveillance systems are becoming increasingly popular. Video surveillance is used, for example, in banks, department stores, industrial areas and even in streets. Prior art video surveillance systems are typically based on the following concept: cameras are installed in the area to be monitored and the pictures taken by them are shown at a control centre. If something suspicious is noticed in a picture at the control centre, guards are dispatched to the scene. Prior art burglar alarm systems usually function as follows: the alarm gives an alarm sound either on the spot, which hopefully will frighten the intruder away, or at the control centre, in which case guards are dispatched to the scene. Thus prior art burglar alarm and video surveillance systems usually require personnel for the actual surveillance, and therefore they are relatively expensive or ineffective as they are based on the deterring effect only: in cities very few passers-by pay any attention to the sound of a burglar alarm since various false alarms are so frequent. Furthermore, it may be expensive to lay telephone lines required by the surveillance and burglar alarm systems to a holiday cottage, for example, and overhead lines are easily damaged by snow or storms. As the general insecurity increases, private individuals are more and more willing to protect their property. Thus a need has arisen to develop a video surveillance system suitable for the mass market.

### BRIEF DESCRIPTION

The object of the invention is to provide a method and an apparatus implementing the method to achieve an improved video surveillance method and video surveillance system. This is achieved by a video surveillance method in a radio telecommunications system, which comprises a video camera system, a detector, a connecting device and at least one user terminal. The method of the invention comprises monitoring a space under surveillance by at least one detector, and, if the detector makes a pre-determined observation, transmitting an alarm message to the connecting device, which transmits the message to at least one user terminal, taking a pre-determined number of pictures at pre-determined intervals by at least one video camera of the video system, transmitting pictures that have been processed as required by the transmission method to the connecting device, transmitting pictures that have been processed as required by the transmission method from the connecting device to at least one user terminal.

The invention also relates to a video surveillance method in a radio telecommunications system, which comprises a video camera system, a surveillance arrangement, a connecting device and a user terminal. The method of the invention comprises monitoring a space under surveillance by at least one surveillance arrangement and, if the surveillance arrangement detects something to report, transmitting a notification to the connecting device, which transmits the notification to at least one user terminal, taking a pre-determined number of pictures at pre-determined intervals by at least one video camera of the video system, transmitting pictures that have been processed as required by the transmission method to the connecting device, transmitting pictures that have been processed as required by the transmission method from the connecting device to at least one user terminal.

The invention further relates to a video surveillance method in a radio telecommunications system, which comprises a video camera system, a connecting device and at least one user terminal. The method of the invention comprises transmitting commands concerning at least one video camera of the video system from the user terminal to the connecting device, transmitting the commands from the connecting device to at least one video camera of the video system, taking a pre-determined number of pictures at pre-determined intervals by at least one video camera of the video system, transmitting pictures that have been processed as required by the transmission method to the connecting device, transmitting pictures that have been processed as required by the transmission method from the connecting device to at least one user terminal.

The invention further relates to a video surveillance system which comprises a video camera system, a detector, a connecting device and at least one user terminal. The system comprises means for monitoring a space under surveillance, means for transmitting an alarm message over the radio path to the connecting device, which transmits the message over the radio path to at least one user terminal, the system comprises means for taking a pre-determined number of pictures at pre-determined intervals, means for transmitting pictures that have been processed as required by the transmission method over the radio path to the connecting device, and means for further transmitting pictures that have been re-processed as required by the transmission method, if necessary, over the radio path to at least one user terminal.

The invention further relates to a video surveillance system which comprises a video camera system, a surveillance system, a connecting device and at least one user terminal. The system comprises means for monitoring a space under surveillance, means for transmitting a notification over the radio path to the connecting device, which transmits the notification over the radio path to at least one user terminal, the system comprises means for taking a pre-determined number of pictures at pre-determined intervals, means for transmitting pictures that have been processed as required by the transmission method to the connecting device over the radio path and means for transmitting pictures that have been re-processed as required by the transmission method, if necessary, over the radio path to at least one user terminal.

The invention further relates to a video surveillance system which comprises a video camera system, a surveillance system, a connecting device and at least one user terminal. The system comprises means for transmitting commands concerning at least one video camera of the video system over the radio path from the user terminal to the connecting device and means for further transmitting the commands over the radio path to at least one video camera of the video system, means for taking a pre-determined number of pictures at pre-determined intervals, the system comprises means for transmitting pictures that have been processed as required by the transmission method over the radio path to the connecting device and means for further transmitting pictures that have been re-processed according to the transmission method, if necessary, over the radio path to at least one user terminal.

The invention further relates to a camera application module for a video surveillance system. The camera application module comprises means for receiving commands transmitted from the user terminal via the connecting device and/or the camera application module comprises means for receiving a start signal transmitted from a detector or a surveillance arrangement, the camera application module comprises means for controlling the camera according to the commands or the start signal, the camera application module comprises means for encoding the picture to be transmitted as required by the transmission method, the camera application module comprises means for transmitting messages and/or pictures to the user terminal via the connecting device.

The preferred embodiments of the invention are disclosed in the dependent claims.

The invention is based on monitoring. a space under surveillance by a detector, e.g. a motion detector, and/or by a surveillance arrangement, such as a thermometer. When the detector makes an observation on which an alarm should be given or which should be reported, information on this is transmitted via a connecting device, which is preferably a wireless modem, to a user terminal as a text message, for example. The user terminal gives commands concerning the video camera system via the connecting device and one or more cameras take pictures of the space under surveillance. Starting of videoing can also be implemented as an automatic function connected to the detector. Pictures are transmitted to the user terminal via the connecting device, either as an e-mail to an e-mail server or as a multimedia message to a multimedia user terminal.

The method and system of the invention provide several advantages. The method of the invention enables implementation of video surveillance at lower costs than the prior art methods since telephone lines or surveillance personnel are not necessarily needed. The method is also fast and easy to use. Furthermore, the video surveillance system of the invention can be remote-controlled by commands transmitted from the user terminal.

### BRIEF DESCRIPTION OF THE FIGURES

The invention will now be described in greater detail by means of preferred embodiments, with reference to the accompanying drawings, in which

FIG. 1 shows an example of a telecommunications system,

FIG. 2 shows another example of a telecommunications system,

FIGS. 3a to c show an example of prior art video encoding,

FIG. 4 is a flow chart,

FIG. 5 is a second flow chart,

FIG. 6 is a third flow chart,

FIG. 7 shows an example of a telecommunications system where a preferred embodiment of the method of the invention is applicable,

FIG. 8 shows a second example of a telecommunications system where a preferred embodiment of the method of the invention is applicable,

FIG. 9 shows a third example of a telecommunications system where a preferred embodiment of the method of the invention is applicable,

FIG. 10 shows an example of a camera application module.

### DESCRIPTION OF THE EMBODIMENTS

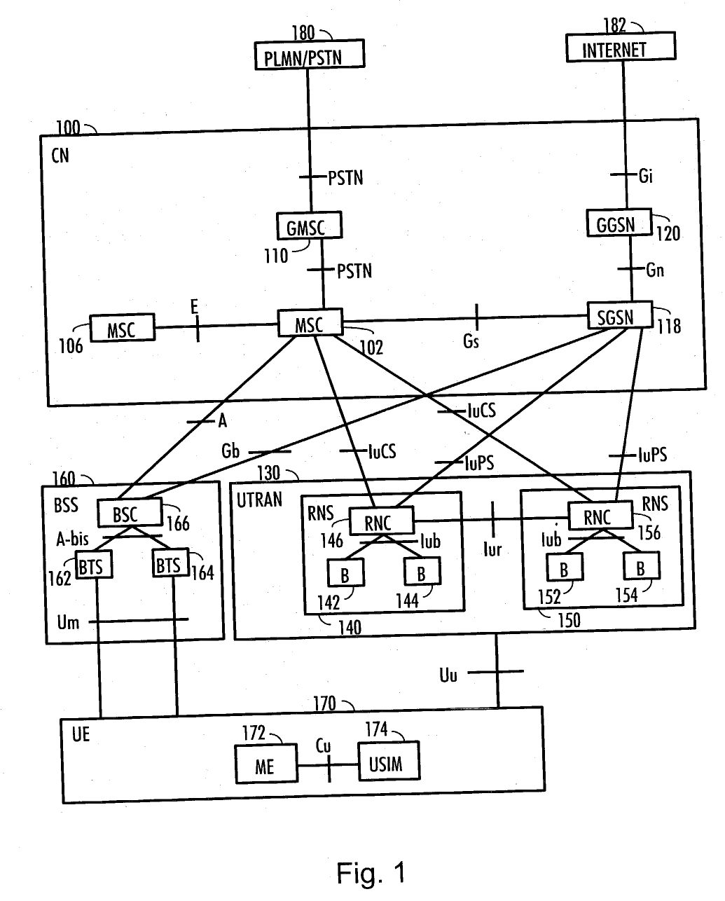

Since the radio systems of the second and the third generation and their various hybrids, i.e. radio systems of the 2.5 generation, are in use worldwide and under constant development, in FIG. 1 the embodiments are described in a simplified radio system, which comprises network elements from different generations in parallel. In the description, the radio system of the second generation is represented by the GSM (Global System for Mobile Communications), the third generation radio system by a radio system which is based on the GSM, uses the EDGE technique (Enhanced Data Rates for Global Evolution) for increasing the data transmission rate, and can also be used for implementing packet transmission in the GPRS system (General Packet Radio System). The third generation radio system is also represented by a radio system which is known at least by the names IMT-2000 (International Mobile Telecommunications 2000) and UMTS (Universal Mobile Telecommunications System). The embodiments are not, however, restricted to these systems given as examples but a person skilled in the art may apply the solution in other radio systems provided with the necessary properties.

FIG. 1 is a simplified block diagram, which describes the most important network elements of the radio system and the interfaces between them. The structure and function of the network elements are not described in detail because they are generally known.

The main parts of the radio system are a core network (CN) 100, a radio access network 130 and user equipment (UE) 170. The term UTRAN is an abbreviation from UMTS Terrestrial Radio Access Network, i.e. the radio access network belongs to the third generation and is implemented by wideband code division multiple access WCDMA. FIG. 1 further illustrates a base station system 160, which belongs to the 2/2.5 generation and is implemented by time division multiple access TDMA.

Generally, the radio system can also be defined as follows: the radio system consists of a user terminal, which is also called a subscriber terminal or a mobile station, and of a network part, which includes the fixed infrastructure of the radio system, i.e. a core network, a radio access network and a base station system.

The structure of the core network 100 corresponds to a combined structure of the GSM and GPRS systems. The network elements of the GSM are responsible for implementing circuit-switched connections and the network elements of the GPRS are responsible for implementing packet-switched connections. However, some of the network elements are included in both systems.

A mobile services switching centre (MSC) 102 is the centre of the circuit-switched side of the core network 100. The same mobile services switching centre 102 can be used to serve the connections of both the radio access network 130 and the base station system 160. The tasks of the mobile services switching centre 102 typically include switching, paging, user terminal location registration, handover management, collection of subscriber billing information, data encryption parameter management, frequency allocation management and echo cancellation.

The number of mobile services switching centres 102 may vary: a small network operator may have only one mobile services switching centre 102, whereas large core networks 100 may have several ones. FIG. 1 shows another mobile services switching centre 106 but its connections to other network elements are not illustrated to keep FIG. 1 sufficiently clear.

Large core networks 100 may comprise a separate gateway mobile services switching centre (GMSC) 110, which is responsible for circuit-switched connections between the core network 100 and the external networks 180. The gateway mobile services switching centre 110 is located between the mobile services switching centres 102, 106 and the external networks 180. The external network 180 may be, for example, a public land mobile network PLMN or a public switched telephone network PSTN.

The core network 100 typically comprises other parts, too, such as a home location register HLR, which includes a permanent subscriber register and, if the radio system supports the GPRS, a PDP address (PDP=Packet Data Protocol), and a visitor location register VLR, which includes information on roaming of the user terminals 170 in the area of the mobile services switching centre 102. Not all parts of the core network are shown in FIG. 1 to keep it clear.

A serving GPRS support node (SGSN) 118 is the centre of the packet-switched side of the core network 100. The main task of the serving GPRS support node 118 is to transmit and receive packets with the user terminal 170 supporting packet-switched transmission, utilizing the radio access network 130 or the base station system 160. The serving GPRS support node 118 includes user information and location information on the user terminal 170.

A gateway GPRS support node (GGSN) 120 on the packet-switched side corresponds to the gateway mobile services switching centre 110 of the circuit-switched side, with the exception that the gateway GPRS support node 120 has to be able to route outgoing traffic from the core network 100 to external networks 182, whereas the gateway mobile services switching centre 110 routes only the incoming traffic. In the example, the external networks 182 are represented by the Internet, via which a considerable part of wireless telephone traffic can be transmitted in the future.

The base station system 160 consists of a base station controller (BSC) 166 and base transceiver stations (BTS) 162, 164. The base station controller 166 controls the base transceiver stations 162, 164. In principle, the devices implementing the radio path and their functions should be located in the base transceiver station 162, 164 and the management devices in the base station controller 166. The implementation may naturally deviate from this principle.

The base station controller 166 is usually responsible for the following tasks, for example: management of the radio resources of the base transceiver station 162, 164, intercell handover, frequency management, i.e. allocation of frequencies to the base transceiver stations 162, 164, management of frequency hopping sequences, measurement of time delays on the uplink, implementation of the operation and management interface, and management of power control.

The base station 162, 164 includes at least one transceiver which forms one carrier wave. In the GSM systems, one carrier wave usually comprises eight time slots, i.e. eight physical channels. One base station 162, 164 may serve one cell or several sectorized cells. The cell diameter may vary from a few metres to dozens of kilometres. The base station 162, 164 is often deemed to include a transcoder, too, for performing conversion between the speech coding format used in the radio system and the speech coding format used in the public switched telephone system. In practice the transcoder, however, is usually located in the mobile services switching centre 102. The base station 162, 164 is usually responsible for the following tasks, for example: calculation of a TA (timing advance), measurements on the uplink, channel coding, encryption of coding, decryption and frequency hopping.

The radio access network 130 consists of radio network sub-systems 140, 150. Each radio network subsystem 140, 150 consists of radio network controllers (RNC) 146, 156 and B nodes 142, 144, 152, 154. The B node is rather an abstract concept, which is frequently replaced by the term ‘base station’.

In respect of its functionality the radio network controller 140, 150 approximately corresponds to the base station controller 166 of the GSM system and the B node 142, 144, 152, 154 to the base station 162, 164 of the GSM system. Solutions are also available where the same device functions both as the base station and as the B node, i.e. the device can simultaneously implement the TDMA and the WCDMA radio interface.

The user terminal 170 consists of two parts: mobile equipment (ME) 172 and a UMTS subscriber identity module (USIM) 174. In the GSM system the identity module of the system is naturally used. The user terminal 170 comprises at least one transceiver for establishing a radio connection to the radio access network 130 or to the base station system 160. The user terminal 170 may include at least two different subscriber identity modules. In addition, the user terminal 170 comprises an antenna, a user interface and a battery. Nowadays various kinds of user terminals 170 are available, e.g. terminals that are installed in a car and portable terminals. The user terminals 170 also have properties similar to those of a personal computer or a portable computer.

The USIM 174 includes information on the user and information on data security, e.g. an encryption algorithm, in particular.

In the following, the interfaces between different network elements shown in FIG. 1 are presented in Table 1. It is obvious to a person skilled in the art that the interfaces included in the radio telecommunications system are determined by the hardware implementation and the standard used, for which reason the interfaces of the system may differ from those shown in FIG. 1. In the UMTS, the most important interfaces are the lu interface between the core network and the radio access network, which is divided into the luCS (CS=Circuit Switched) interface of the circuit-switched side and the luPS (PS=Packet Switched) interface of the packet-switched side, and the Uu interface between the radio access network and the user terminal. In the GSM, the most important interfaces are the A interface between the base station controller and the mobile services switching centre, the Gb interface between the base station controller and the serving GPRS support node, and the Um interface between the base station and the user terminal. The interface defines what kind of messages different network elements may use to communicate with one another. The object of the standardisation of interfaces is to enable function between network elements of different producers. In practice, however, some of the interfaces are producer-specific.

TABLE 1

| Interface | Between network elements |
|---|---|
| Uu | UE-UTRAN |
| Iu | UTRAN-CN |
| IuCS | UTRAN-MSC |
| IuPS | UTRAN-SGSN |
| Cu | ME-USIM |
| Iur | RNC—RNC |
| Iub | RNC-B |
| A | BSS-MSC |
| Gb | BSC-SGSN |
| A-bis | BSC-BTS |
| Um | BTS-UE |
| E | MSC—MSC |
| Gs | MSC-SGSN |
| PSTN | MSC-GMSC |
| PSTN | GMSC-PLMN/PSTN |
| Gn | SGSN-GGSN |
| Gi | GGSN-INTERNET |

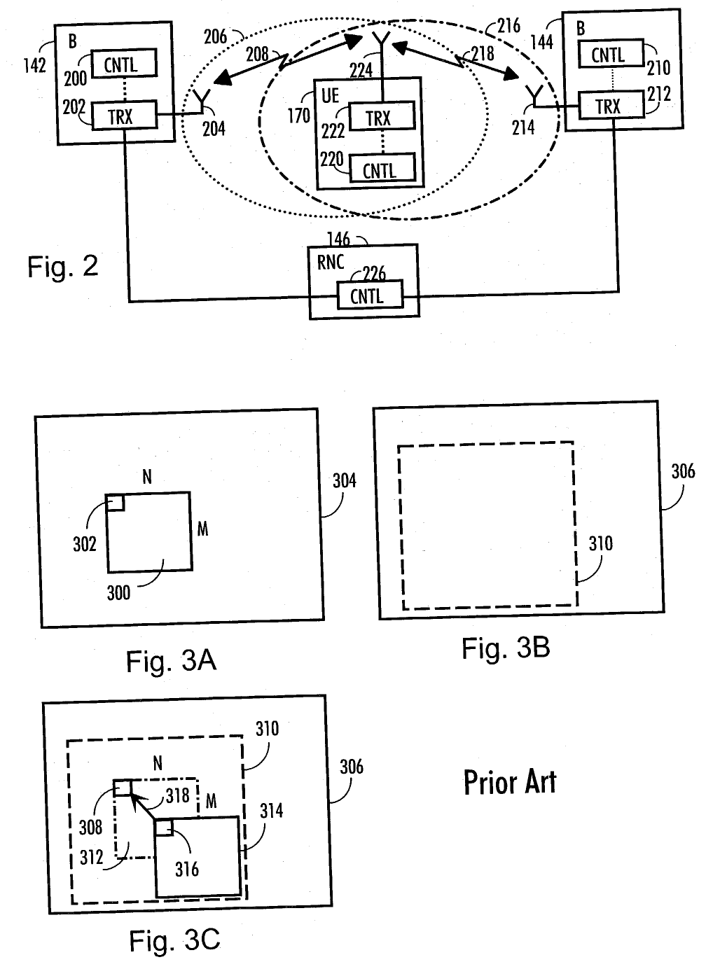

In the following, a cellular WCDMA radio telecommunications system will be described by means of FIG. 2. FIG. 2 shows part of a simplified radio system, which comprises a subscriber terminal 170, two base stations 142, 144 and a base station controller 146. The first base station 142 comprises a transceiver 202, an antenna 204 and a control block 200. Likewise, the second base station 144 comprises a transceiver 212, an antenna 214 and a control block 210. The base station controller 146 also comprises a control block 226. The user terminal 170 also comprises a normal transceiver 222 and an antenna for establishing a radio connection and a control block 220. The transceivers 202, 212, 222 use the CDMA technology (Code Division Multiple Access). In the CDMA technology, i.e. in code division multiple use, radio resources are allocated to each user by means of user-specific codes. The technique is generally known, for which reason it will not be described in greater detail here. The antennas 204, 214, 224 can be implemented by common prior art solutions, e.g. as omnidirectional antennas or as antennas employing a directed antenna beam.

In the radio telecommunications system, the radio cells created by base stations usually overlap to some extent to provide extensive coverage. This is illustrated in FIG. 2 by a radio cell 206 created by the base station 142 and a radio cell 216 created by the base station 144. In the existing radio telecommunications systems, wireless telecommunications connections are established by user terminals and base stations which communicate with one another on a radio connection, i.e. calls or data transmission connections between different user terminals are established via base stations. This is illustrated in FIG. 2 by radio connections 208, 218. In particular, FIG. 2 shows a situation where a user terminal 170, which may be mobile, communicates over a radio connection with the first base station 142, simultaneously measuring common pilots of this base station 142 and the second base station 144 for a possible handover. In a typical situation the radio connection of the user terminal shifts to the carrier wave of the second base station when there is free capacity in the new cell and the new connection has a better quality. Channel and cell handovers enable continuity of the radio connection when the user terminal moves or the physical radio channel changes as a function of time.

The control blocks 200, 210, 220, 226 refer to a block which controls the function of the device and which is nowadays usually implemented as a processor and its software, but various hardware solutions are also feasible, e.g. a circuit built from logic components or one or more application specific integrated circuits ASIC. A hybrid of these different implementations is also feasible. When selecting the implementation method, a person skilled in the art will consider the requirements set on the size and power consumption of the device, the necessary processing capacity, the production costs and the production volumes.

Further information on radio telecommunications systems is available in the literature and standards on the field.

In the following, prior art examples of encoding of moving or still video pictures for transmission over the radio path will be described briefly. Transmission of video picture in telecommunications systems, such as video phones (or multimedia phones), in video conferencing systems or over Internet connections is a demanding task due to the large amount of data needed to transfer a video picture: the larger the number of bits needed to transmit data, the higher the data transmission rate has to be. Different methods have been devised to solve this problem. For transmission a picture is typically divided into image blocks whose size is selected to suit the system. Information on the image block usually comprises information on the luminance, colour and location of the image block in the picture. The data included in the image blocks are compressed block by block by the desired encoding method. Compression is based on deleting less significant data. Compression methods are principally divided into three categories: spectral redundancy reduction, spatial redundancy reduction and temporal redundancy reduction. Different combinations of these methods are typically used for compression.

A YUV colour model, for example, is employed to reduce spectral redundancy. The YUV model utilizes the fact that the human eye is more sensitive to variations in luminance than to variations in chrominance, i.e. colour. The YUV model includes one luminance component (Y) and two chrominance components (U, V). The chrominance components are also downsampled. A luminance block according to the H.263video encoding standard, for example, is 16×16 pixels and both chrominance blocks, which cover the same area as the luminance block, are 8×8 pixels. In the standard concerned the combination of one luminance block and two chrominance blocks is called a macroblock.

A discrete cosine transform DCT where the block to be compressed is preferably 8×8 pixels is used in the reduction of spatial redundancy, for instance. In the DCT transform the pixel presentation of an image block is converted into a space-frequency presentation. In addition, in the image block only the signal frequencies that occur in the block have high-amplitude coefficients, whereas the coefficients of the signals that do not exist in the image block are close to zero. The DCT is also a loss-free transform, and interference is generated in the signal only in quantization.

Temporal redundancy is reduced utilizing the fact that successive pictures usually resemble each other. Thus instead of compressing each picture, motion data are generated on image blocks. The basic principle is the following: as good a reference block as possible that has been encoded earlier is searched for the image block to be encoded, the motion between the reference block and the image block is modelled and the calculated motion vector coefficients are transmitted to the receiver. The difference between the block to be encoded and the reference block is expressed as a prediction error component (prediction error frame).

The purpose of video picture encoding is to reduce the number of bits needed to transmit pictures. FIGS. 3a to c illustrate a simplified prior art motion encoding method, which is based on motion vector prediction of the image block (in the text the term ‘block’ is also used) using a reference picture (reference frame) stored in the memory earlier. This kind of encoding is called interceding, which means utilization of similarities between the pictures of the same picture sequence in compression encoding.

In the example of FIGS. 3a to c, the reference picture (reference frame) 306 has been divided into blocks or segments and it has been encoded earlier. Image blocks are not illustrated in FIGS. 3b to c. The reference picture may be in the picture sequence before the picture to be encoded or after it. FIG. 3a also shows the current frame 304 to be encoded, which has also been divided into blocks, of which only one 300 is illustrated for the sake of clarity. The size of the blocks is N×M. The blocks are typically squares, i.e. N=M, but they can also be rectangular, for example. The block 300 to be encoded and the reference block 314 shown in FIG. 3c do not need to have the same geometrical shape because in reality the objects to be imaged also change, e.g. they rotate or twist. The size and shape of a block are defined to suit a given situation, considering e.g. the following issues: a small block size yields a more accurate picture, but reduces the reliability of the motion vector coefficient determined because the determination is based on only a few pixels. Furthermore, if smaller blocks are used, more motion vector data needs to be generated because the picture has to be divided into more blocks. In addition, fast algorithms are more effective in the determination of motion vector coefficients when the block size is large, e.g. N=M=16 in some existing video encoding standards.

To predict motion, the reference picture 306 is searched for as accurate a reference block as possible for the block 300 to be encoded. In FIG. 3c this block is 314. Which reference block is most suitable depends on the selection criterion. The selection criterion is typically used to find a block that allows minimization of the number of bits needed to transmit the block to be encoded while the picture quality is sufficiently good. Thus the selection criteria may vary according to the application.

The search is usually carried out in the area of the reference picture 306 that is in the same place as the block 300 to be encoded in the picture 304 to be encoded and in a certain area in immediate vicinity, which is represented by search area 310 in FIGS. 3b to c. By defining the search area as smaller than the whole reference picture, the time and the number of calculations needed for the search can be reduced. The size of the search area is defined to suit the application e.g. by concluding from the pictures of the picture sequence that have been encoded earlier whether motion is slow or fast; if the motion is slow, the search area can be defined as smaller than in the case the motion is fast. The search is typically carried out near the predicted motion vector coefficient.

In the example of FIGS. 3a to c, the location of the picture block is given by (x, y) coordinates in the left top corner of the block. Coordinate x represents the location of a pixel or block in the horizontal direction and coordinate y represents the location of a pixel or block in the vertical direction. The coordinates of the block to be encoded are denoted by 302. In FIG. 3c the best reference picture block 414 has been found in search area 310. Coordinates (x, y) 308 are the coordinates of the location where the block 300 to be encoded would be if it had not moved, and thus they are the same as coordinates 302. These are illustrated for the sake of clarity. Block 312 describes block 300 if it had not moved, and it is also shown for the sake of clarity. Now the motion of the image block to be encoded can be expressed as a change from coordinates (x+u, y+v) 316 into coordinates (x,y) 308. Usually the coordinates (x,y) are defined as the origin and thus the motion vector coefficient 318 of the block to be encoded can be expressed as coordinates (u,v). The motion vector can also be expressed using the determination of motion vector coefficients and motion models.

Prior art encoding methods of both moving and still pictures are described in the literature and standards on the art, for which reason they will not be presented here in greater detail. Prior art video encoding methods include JPEG for still pictures and MPEG for moving pictures, for instance. The video picture is encoded in a transmitter and decoded in the receiver in the same way as other encodable radio transmissions.

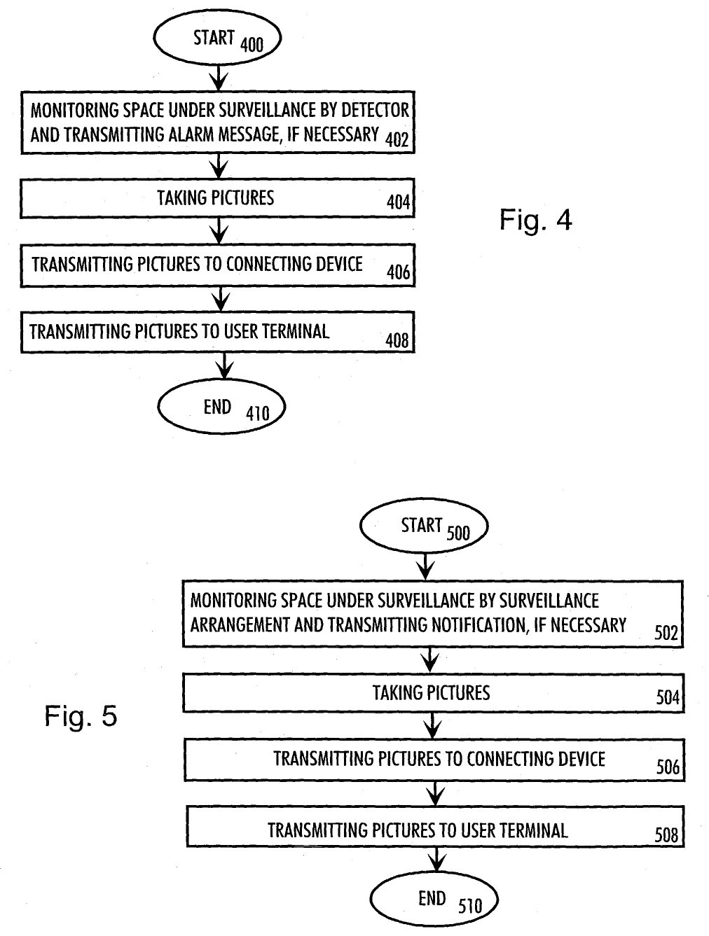

In the following, a video surveillance system according to a first preferred embodiment of the invention in a radio telecommunications system will be described by means of FIG. 4. The video surveillance radio telecommunications system comprises a video camera system, a detector, a connecting device and at least one user terminal. The video camera system consists of one or more video cameras. A video camera preferably includes a camera application module or communicates with it. The camera application module will be described in greater detail in connection with FIG. 10.

A human reflects electromagnetic radiation differently than building materials, for example. Furthermore, a human being often radiates more thermal energy than the environment. Several sensors for detecting unauthorized presence, such as motion detectors, are typically based on the above-mentioned properties. The detector of the video surveillance system is, for example, a motion detector based on the utilization of infrared waves, a detector for detecting breaking of a window, a photocell or a similar prior art detector used in surveillance or burglar alarm systems. As the technology advances, the detector may in the future be based on a video picture analysis carried out by the video camera itself or by a computer system attached thereto. The detector may be a separate device, a unit consisting of several separate devices or a unit integrated into the video camera, for example.

The connecting device is preferably a wireless modem. The user terminal may be a terminal provided with a wireless Internet connection, such as a palmtop or a portable PC, or a terminal of the cellular radio system, such as a portable videophone (also called a multimedia phone).

The video surveillance system of the invention is typically connected to a prior art burglar alarm or surveillance system to monitor a holiday home, a pleasure boat, a home, a garage, a car or a yard. There are various prior art burglar alarm or surveillance systems and the application of the invention does not restrict the selection of the system. Thus they will not be described in greater detail here.

The method starts in block 400. In block 402 the space under surveillance is monitored by at least one detector and if the detector makes a pre-determined observation, an alarm message is transmitted to the connecting device, which transmits the message to at least one user terminal. The type of the pre-determined observation depends on the detector: for example, if the detector is a motion detector, the observation is a motion in the area under surveillance. The alarm message can be a picture message, a textual message or a voice message, e.g. a call. The alarm can also be expressed as a voice signal in the user terminal and/or at the location under surveillance. The alarm message is transmitted e.g. as a text message, i.e. in SMS format (SMS, Short Message Service).

The method of the invention can also be combined with prior art alarm systems, in which case the alarm message can also be transmitted to a police department or to a guarding company, for instance.

In block 404 a pre-determined number of pictures are taken at pre-determined intervals by at least one video camera. For example, pictures can be taken at pre-determined intervals or until a command to stop videoing is received. Pictures can also be taken for a certain time or a certain number of pictures can be taken. The manner of videoing depends on the application. A moving picture is typically obtained by taking several successive pictures at short intervals and by showing the pictures one after another so that they appear as a moving picture to the eye.

In block 406 moving or still pictures that have been processed as required by the transmission method are transmitted to the connecting device. Encoding of moving and still pictures was explained briefly above in this application. In addition, picture messages are processed according to the telecommunications protocol used. Picture messages can be transmitted to the connecting device e.g. as MIME (Multipurpose Internet Mail Extensions) encoded SMPT e-mail messages (SMTP=Simple Mail Transfer Protocol) or as messages in accordance with the WAP protocol.

In block 408 pictures that have been processed as required by the transmission method are transmitted from the connecting device to at least one user terminal. The pictures can be transmitted e.g. as e-mail or as packet data over a cellular radio network or via the Internet. In the GSM network, for example, pictures can be transmitted as MMS, i.e. as multimedia messages via a multimedia messaging system centre MMSC to a multimedia phone or via the e-mail gateway of the MMSC to the user's e-mail.

The method ends in block 410.

The method may also comprise transmission of commands from the user terminal to the video camera arrangement via the connecting device. The commands can be used for controlling one or more cameras of the video system. The commands can control the camera to start videoing, focus, stop videoing, take a certain number of pictures, take pictures at certain intervals, turn or the like. Naturally the video camera system can be controlled by the commands given from the user terminal during the videoing, too. Furthermore, lights, for example, can be connected to the system to illuminate the object to be videoed better or to scare the intruder away.

The commands have e.g. the following format: password, command, property to be changed. The password can be used to protect the system from outsiders so that a possible intruder cannot switch the system off. The password can also be used to direct the commands at the desired surveillance system. For the system to be practical in the mass market, it is essentially important that commands are directed at the correct object. This can naturally also be implemented without a password, e.g. by giving address information or other identification data. The commands can also be encoded at the interface to encrypt the message. Encryption is usually automatic both in the GSM and in the UMTS system. The commands are transmitted as SMS messages, for example.

It should be noted that sounds from the location under surveillance, textual information on the cause for the alarm or similar information can also be transmitted with the picture files. The video camera system, a single camera or other devices connected to the system can be controlled by commands transmitted by means of the user terminal and the connecting device during the videoing, too, or the videoing can be started without an alarm.

In the following, the video surveillance method of a second preferred embodiment of the invention will be described in a radio telecommunications system by means of FIG. 5. The video surveillance radio telecommunications system comprises a video camera system, a surveillance arrangement, a connecting device and at least one user terminal. The video camera system consists of one or more video cameras. A video camera preferably also comprises a camera application module or is connected thereto. The camera application module will be described in greater detail in connection with FIG. 10.

The connecting device is preferably a wireless modem. The user terminal may be a terminal provided with a wireless Internet connection, such as a palmtop or a portable PC, or a terminal of the cellular radio system, such as a portable videophone (also called a multimedia phone).

The location to be monitored can be a home, a holiday home, a storage room, a freezer or another similar space or device which is to be monitored for water damage, frost damage or the like. The surveillance arrangement may be a thermometer, a moisture sensor, a pressure meter or a similar device or their combination. Naturally the surveillance arrangement can be connected to a burglar alarm system, for instance. The method starts in block 500.

In block 502 the location under surveillance is monitored by at least one surveillance arrangement. If the surveillance arrangement detects something to report, a notification is transmitted to the connecting device, which transmits the notification to at least one user terminal. The thing to be reported may be e.g. a decrease in the temperature below a set minimum, an increase in the temperature above a set maximum, the moisture percentage, the level of water surface or breaking of a window. Monitoring for a power cut is most preferably performed as follows: an alarm is triggered if the battery back-up of the video camera is switched on or the battery is used beyond a given time limit.

The notification may be a picture message, a textual message or a voice message, e.g. a call. The notification can also be given as a sound signal in the user terminal and/or at the location under surveillance. The alarm message is transmitted e.g. as a text message, i.e. in SMS format (SMS, Short Message Service). The notification can also be sent to a maintenance man, for example.

In block 504 a pre-determined number of pictures are taken at pre-determined intervals by at least one video camera. For example, pictures can be taken at pre-determined intervals or until a command to stop videoing is received. Pictures can also be taken for a certain time or a certain number of pictures can be taken. The manner of videoing depends on the application. A moving picture is typically obtained by taking several successive pictures at short intervals and by showing the pictures one after another so that they appear as a moving picture to the eye.

In block 506 moving or still pictures that have been processed as required by the transmission method are transmitted to the connecting device. Encoding of moving and still pictures was explained briefly above in this application. In addition, picture messages are processed according to the telecommunications protocol used. Picture messages can be transmitted to the connecting device e.g. as MIME (Multipurpose Internet Mail Extensions) encoded SMPT e-mail messages (SMTP=Simple Mail Transfer Protocol) or as messages in accordance with the WAP protocol.

In block 508 pictures that have been processed as required by the transmission method are transmitted from the connecting device to at least one user terminal. The pictures can be transmitted e.g. as e-mail or as packet data in a cellular radio network or via the Internet. In the GSM network, for example, pictures can be transmitted as MMS, i.e. as a multimedia message via a multimedia messaging system centre MMSC to a multimedia phone or via the e-mail gateway of the MMSC to the user's e-mail.

The method ends in block 510.

The method may also comprise transmission of commands from the user terminal to the video camera arrangement via the connecting device. The commands can be used for controlling one or more cameras of the video system. The commands can control the camera to start videoing, focus, stop videoing, take a certain number of pictures, take pictures at certain intervals, turn or the like. Naturally the video camera system can be controlled by the commands given from the user terminal during the videoing, too. Lights, for example, can be connected to the system to illuminate the object to be videoed better.

The commands have e.g. the following format: password, command, property to be changed. The password can be used to protect the system from outsiders so that a possible intruder cannot switch the system off. The password can also be used to direct the commands at the desired surveillance system. For the system to be practical in the mass market, it is essentially important that commands are directed at the correct object. This can naturally also be implemented without a password, e.g. by giving address information or other identification data. The commands can also be encoded at the interface to encrypt the message. The commands are transmitted as SMS messages, for example.

It should be noted that sounds from the location under surveillance can also be transmitted with the picture files. The video camera system, a single camera or other devices connected to the system can be controlled by commands transmitted by means of the user terminal and the connecting device during the videoing, too, or the videoing can be started without a notification.

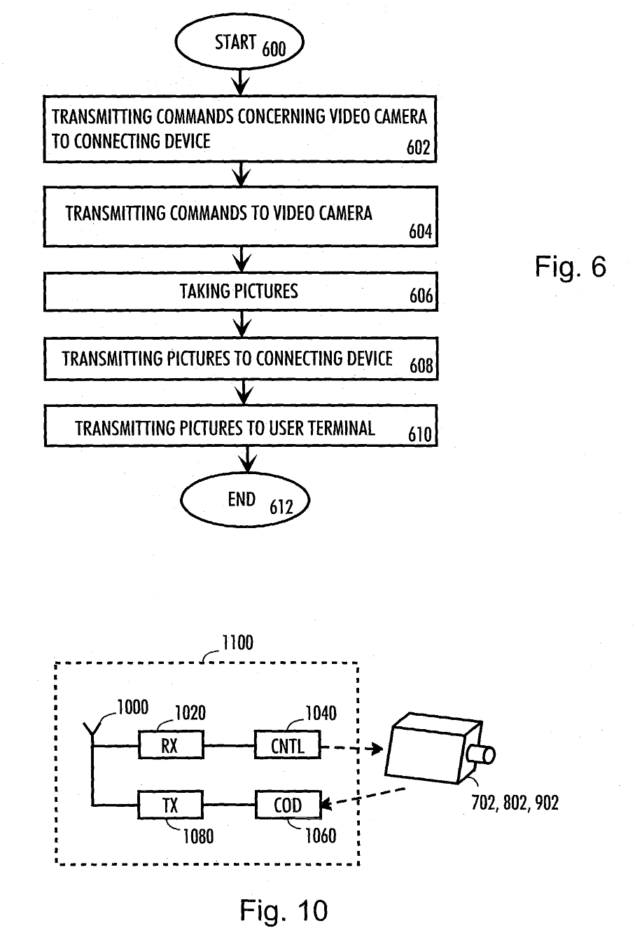

In the following, the video surveillance method according to the third preferred embodiment of the invention in a radio telecommunications system will be described by means of FIG. 6. The video surveillance system comprises a video camera system, a connecting device and a user terminal. The video camera preferably also comprises a camera application module or is connected thereto. The camera application module will be described in greater detail in connection with FIG. 10.

The method starts in block 600.

In block 602 commands related to at least one video camera are transmitted from the user terminal to the connecting device. The commands can be used for controlling one or more cameras of the video system. The commands can control the camera to start videoing, focus, stop videoing, take a certain number of pictures, take pictures at certain intervals, turn or the like. Naturally the video camera system can be controlled by the commands given from the user terminal during the filming, too. Lights, for example, can be connected to the system to illuminate the object to be videoed better or to scare the intruder away.

The commands have e.g. the following format: password, command, property to be changed. The password can be used to protect the system from outsiders so that a possible intruder cannot switch the system off.

The connecting device is preferably a wireless modem. The user terminal may be a terminal provided with a wireless Internet connection, such as a palmtop or a portable PC, or a terminal of the cellular radio system, such as a portable videophone (also called a multimedia phone).

In block 604 the commands are transmitted from the connecting device to at least one video camera. A password, for example, can be used to direct the commands at the desired system. For the system to be practical in the mass market, it is essentially important that commands are directed at the correct object. This can naturally also be implemented without a passord, e.g. by giving address information or other identification data. The commands can also be encoded at the interface to encrypt the message. The commands are transmitted as SMS messages, for example.

In block 606 a pre-determined number of pictures are taken at pre-determined intervals by at least one video camera. For example, pictures can be taken at pre-determined intervals or until a command to stop videoing is received. Pictures can also be taken for a certain time or a certain number of pictures can be taken. The manner of videoing depends on the application. A moving picture is typically obtained by taking several successive pictures at short intervals and by showing the pictures one after another so that they appear as a moving picture to the eye.

In block 608 moving or still pictures that have been processed as required by the transmission method are transmitted to the connecting device. Encoding of moving and still pictures was explained briefly above in this application. In addition, picture messages are processed according to the telecommunications protocol used. Picture messages can be transmitted to the connecting device e.g. as MIME (Multipurpose Internet Mail Extensions) encoded SMPT e-mail messages (SMTP=Simple Mail Transfer Protocol) or as messages in accordance with the WAP protocol.

In block 610 pictures that have been processed as required by the transmission method are transmitted from the connecting device to at least one user terminal. The pictures can be transmitted e.g. as e-mail or as packet data in a cellular radio network or via the Internet. In the GSM network, for example, pictures can be transmitted as MMS, i.e. as multimedia messages via a multimedia messaging system centre MMSC to a multimedia phone or via the e-mail gateway of the MMSC to the user's e-mail.

The method ends in block 612.

It should be noted that sounds from the location under surveillance can also be transmitted with the picture files. The video camera system, a single camera or other devices connected to the system can be controlled by commands transmitted by means of the user terminal and the connecting device during the videoing, too, or the videoing can be started without a notification.

In the following, examples will be described of radio telecommunications systems where the method and its various embodiments described in FIGS. 4 to 6 are applicable. A camera application module, which functions as an adapting device between the cameras and the other devices of the system, will be described in connection with FIG. 10.

FIG. 7 illustrates an example of a video system where the video surveillance method described above is applicable. The example has been simplified for the sake of clarity. The video system comprises at least one detector or surveillance arrangement and at least one camera, a connecting device (one or more but preferably only one), a gateway GPRS support node GGSN, an e-mail inbox, i.e. a dataslot for incoming mail, and one or more user terminals. In FIG. 7 the camera application module is integrated into a video camera 702.

In FIG. 7 the detector or the surveillance arrangement 700 monitors the space where it is located. The space can be a home, a pleasure boat, a holiday home, a yard, a storage room or the like. If the detector detects an intruder or something else to report, it sends information thereon either via the camera module 703 or directly to the connecting device 704, which sends a notice, i.e. an alarm or a notification, to the user terminal. The notice is preferably in textual format and can thus be transmitted as a text message, i.e. as an SMS message. The connecting device 704 is preferably a wireless modem. A command is preferably transmitted as an SMS message to the camera via the connecting device to order the camera to start videoing. Videoing can also start automatically e.g. by means of a notification or start signal given by the detector or the surveillance arrangement. The pictures taken by the camera are encoded into a suitable format so that they can be transmitted via the connecting device to the user terminal over the radio path. The picture can be a moving or a still picture. The gateway GPRS support node GGSN 120 routes packet data from the core networks to external networks and vice versa. In the example, external data networks are represented by an Internet e-mail inbox 710, to which the pictures are submitted from the user terminal 170 for viewing. The pictures can be submitted in SMTP format, for instance. Arrival of the pictures at the e-mail server can be expressed e.g. by an icon on the display of the user terminal or by a sound signal.

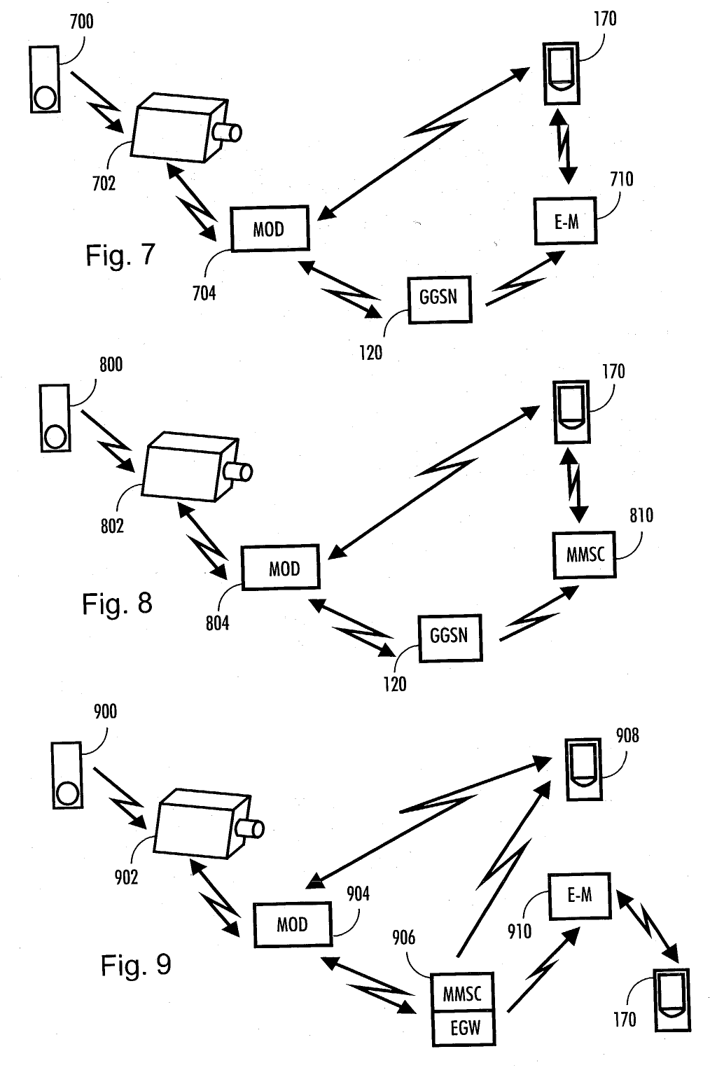

FIG. 8 illustrates a second example of a video system where the video surveillance method described above is applicable. The example has been simplified for the sake of clarity. The video system includes at least one detector or surveillance arrangement and at least one camera, a connecting device (one or more but preferably only one), a gateway GPRS support node GGSN, a multimedia messaging system centre MMSC and one or more multimedia user terminals. In FIG. 8 the camera application module is integrated into a video camera 802.

In FIG. 8 the detector or the surveillance system 800 monitors the space where it is located. The space can be a home, a pleasure boat, a holiday home, a yard, a storage room or the like. If the detector detects an intruder or something else to report, it transmits information thereon either via the camera module 802 or directly to a connecting device 804, which transmits a notice, i.e. a notification or an alarm, to the user terminal. The notice is preferably in textual format and can thus be transmitted as a text message, i.e. as an SMS message. The connecting device 804 is preferably a wireless modem. A command is preferably transmitted as an SMS message from the user terminal to the camera to order the camera to start videoing. Videoing can also start automatically e.g. by means of a notification or start signal given by the detector or the surveillance arrangement. The pictures taken by the camera are encoded into a suitable format so that they can be transmitted via the connecting device to the user terminal over the radio path. The picture can be a moving or a still picture. The gateway GPRS support node GGSN 120 routes packet data from the core networks to the external networks and vice versa. In the example the external data networks are represented by a multimedia messaging system centre MMSC 810, to which the pictures are submitted from the user terminal 170 for viewing. In this example the user terminal is a multimedia user terminal and thus the pictures are multimedia messages MMS (MMS=Multimedia Messaging System).

FIG. 9 illustrates a third example of a video system where the video surveillance method described above is applicable. The example has been simplified for the sake of clarity. The video system includes at least one detector or surveillance arrangement and at least one camera, a connecting device (one or more but preferably only one), a multimedia messaging system centre MMSC, an e-mail gateway EGW and one or more multimedia terminals.

In FIG. 9 a detector or a surveillance arrangement 900 monitors the space where it is located. The space can be a home, a pleasure boat, a holiday home, a yard, a storage room or the like. If the detector detects an intruder or something else to report, it sends information thereon either via the camera module 902 or directly to the connecting device 904, which sends a notice, i.e. an alarm or a notification, to the user terminal. The notification is preferably in textual format, and thus it can be transmitted as a text message, i.e. as an SMS message. The connecting device 904 is preferably a wireless modem. From the user terminal a command is preferably transmitted as an SMS message to the camera via the connecting device to order the camera to start videoing. Videoing can also start automatically e.g. by means of a notification or start signal given by the detector or the surveillance arrangement. The picture can be a moving or a still picture. The pictures taken by the camera are encoded into a suitable format so that they can be transmitted via the connecting device to the user terminal over the radio path. The connecting device transmits the pictures as multimedia messages to a multimedia messaging system centre MMSC 906 in the GSM network for viewing by means of the user terminal 908. The user terminal 908 is a multimedia terminal and thus the messages are multimedia messages MMS (MMS=Multimedia Messaging System). The pictures can also be transmitted via an e-mail gateway EGW of the MMSC to an e-mail server 910, from which they can be viewed by means of the user terminal 170. In that case the pictures are in e-mail format, preferably in SMTP format. In FIG. 9 the camera application module is integrated into a video camera 902.

It should be noted that in the systems exemplified in FIGS. 7, 8 and 9, sound and further information in textual format, such as the location of the motion detector that caused the alarm, can also be transmitted with pictures. The pictures to be transmitted can be moving or still pictures.

In the following, a simplified example of a video application module 1100 of the video surveillance system will be described by means of FIG. 10. The camera application module functions as an adapting device between the cameras belonging to the video surveillance system and the other devices of the system. The camera application module can control one or more cameras. The camera application unit preferably communicates with the connecting device and the detector or the surveillance arrangement over a radio connection. The camera application module may be a separate device, which is attached to the camera or placed near it, or it may be integrated inside the camera. The camera and the camera application module can be fixed to each other e.g. by a cable, or they can communicate over the radio path. It is obvious to a person skilled in the art that the camera application module may also comprise parts other than those shown in FIG. 10.

The camera application module receives commands transmitted from the user terminal via the connecting device or a start signal transmitted from the detector or the surveillance arrangement via an antenna 1000 and a radio receiver 1020. The start signal is e.g. an alarm signal by the detector or a notification by the surveillance arrangement, which is also transmitted to the user terminal. The start signal may also be a separate signal which is generated, if necessary. Transmission of the start signal preferably starts automatically based on the property to be monitored, such as motion, temperature, pressure or sound. The parts of the radio receiver include radio frequency parts, where a received signal is amplified, filtered and down-converted either to an intermediate frequency or directly to the baseband. The radio receiver typically also comprises an A/D converter, which converts an analogue signal into a digital one, and a DSP processor for digital signal processing. Depending on the system, the radio receivers also comprise parts other than those mentioned above. The structure of a radio receiver is well-known in the field, for which reason it will not be described in greater detail here.

The camera application unit controls one or more cameras by means of a control block 1040. The commands can control the camera to start videoing, focus, stop videoing, take a certain number of pictures, take pictures at certain intervals, turn or the like. Naturally the video camera system can be controlled by the commands given from the user terminal during the videoing, too. Other devices, e.g. lights, can be connected to the system to illuminate the object to be videoed better, if necessary.

In coding block 1060 the picture to be transmitted is encoded as required by the transmission method. Examples of encoding of moving and still pictures were explained earlier in this application by means of FIGS. 3a to c. A picture or pictures can also be encoded otherwise for transmission over the radio path, e.g. encrypted. The coding block can also be implemented as one function of the DSP processor. In that case the transmitter and the receiver typically comprise one common DSP processor.

The camera application module transmits messages and/or pictures to the user terminal via the connecting device, the transmitter 1080 and the antenna 1000. In the transmitter the signal to be transmitted is typically D/A converted, up-converted to the transmission frequency and amplified by an antenna amplifier. Depending on the system, the radio transmitters also comprise parts other than those mentioned above. The radio transmitters are generally known in the field, and thus they will not be described in greater detail here. The message transmitted by the camera application module is preferably an alarm message on unauthorized presence or a notification of an observation by the surveillance arrangement. The message is a picture message, a text message or a voice message, for example. The video surveillance method and system were described more closely above.

Messages from the detector or the surveillance arrangement are also received by the antenna 1000 and the radio receiver 1020. The camera application module may control the cameras on the basis of these messages, too.

The invention is preferably implemented by software, in which case the functions of the method described are implemented by software that functions in the system devices (detector, camera, camera application module, connecting device, MMSC, GGSN, user terminal, e-mail server). The invention can also be implemented as hardware solutions which provide the required functionality, e.g. as ASIC (Application Specific Integrated Circuit) or using separate logic components.

Even though the invention was described above with reference to the example according to the enclosed drawings, it is clear that the invention is not limited to it but may be modified in various ways within the inventive concept defined in the appended claims.

We claim:

1. A video surveillance method in a radio telecommunications system, which comprises a video camera system, a detector, a connecting device and at least one user terminal, the method comprising
monitoring a space under surveillance by at least one detector and, if the detector makes a pre-determined observation, transmitting an alarm message to the connecting device, which transmits the message to at least one user terminal,
taking a pre-determined number of pictures at pre-determined intervals by at least one video camera of the video system,
transmitting pictures that have been processed as required by the transmission method to the connecting device,
transmitting pictures that have been processed as required by the transmission method from the connecting device to at least one user terminal.

2. A video surveillance method in a radio telecommunications system, which comprises a video camera system, a surveillance arrangement, a connecting device and a user terminal, the method comprising
monitoring a space under surveillance by at least one surveillance arrangement and, if the surveillance arrangement detects something to report, transmitting a notification to the connecting device, which transmits the notification to at least one user terminal,
taking a pre-determined number of pictures at pre-determined intervals by at least one video camera of the video system,
transmitting pictures that have been processed as required by the transmission method to the connecting device,
transmitting pictures that have been processed as required by the transmission method from the connecting device to at least one user terminal.

3. A video surveillance method in a radio telecommunications system, which comprises a video camera system, a connecting device and at least one user terminal, the method comprising
transmitting commands concerning at least one video camera of the video system from the user terminal to the connecting device,
transmitting the commands from the connecting device to at least one video camera of the video system,
taking a pre-determined number of pictures at pre-determined intervals by at least one video camera of the video system,
transmitting pictures that have been processed as required by the transmission method to the connecting device,
transmitting pictures that have been processed as required by the transmission method from the connecting device to at least one user terminal.

4. A method according to claim 1, further comprising transmitting commands from the user terminal to at least one video camera of the video system via the connecting device.

5. A method according to claim 1, wherein at least one video camera starts videoing at the command of the detector or the surveillance arrangement.

6. A method according to claim 1, wherein the connecting device is a wireless modem.

7. A method according to claim 1, wherein the detector is a motion detector and the pre-determined observation is motion.

8. A method according to claim 1, wherein when the detector makes a pre-determined observation, an alarm is given with a sound signal in the user terminal and/or at the location under surveillance.

9. A method according to claim 1, wherein when the detector makes a pre-determined observation, the alarm message is a picture message (MMS).

10. A method according to claim 1, wherein when the detector makes a pre-determined observation, the alarm message is a textual message.

11. A method according to claim 1, wherein when the detector makes a pre-determined observation, the alarm message is a voice message.

12. A method according to claim 1, wherein the user terminal is a terminal provided with a wireless Internet connection.

13. A method according to claim 1, wherein the user terminal is a video phone.

14. A method according to claim 1, wherein the pictures to be transmitted are still pictures.

15. A method according to claim 1, wherein the pictures to be transmitted are moving pictures.

16. A method according to claim 1, wherein sound is transmitted in addition to the pictures.

17. A method according to claim 3, wherein the notification by the surveillance arrangement is transmitted as a picture message (MMS).

18. A method according to claim 3, wherein the notification by the surveillance arrangement is transmitted as a textual message.

19. A method according to claim 3, wherein the notification by the surveillance arrangement is transmitted as a voice message.

20. A method according to claim 1, wherein the commands concerning the video camera include the following information: password, command and/or property to be changed.

21. A video surveillance system which comprises a video camera system, a detector, a connecting device and at least one user terminal, the system comprising
means for monitoring a space under surveillance,
means for transmitting an alarm message over the radio path to the connecting device, which transmits the message over the radio path to at least one user terminal,
means for taking a pre-determined number of pictures at pre-determined intervals,
means for transmitting pictures processed as required by the transmission method over the radio path to the connecting device and the system comprises means for further transmitting pictures that have been re-processed as required by the transmission method, if necessary, over the radio path to at least one user terminal.

22. A video surveillance system which comprises a video camera system, a surveillance arrangement, a connecting device and at least one user terminal, the system comprising
means for monitoring a space under surveillance,
means for transmitting a notification over the radio path to the connecting device, which transmits the notification over the radio path to at least one user terminal,
means for taking a pre-determined number of pictures at pre-determined intervals,
means for transmitting pictures that have been processed as required by the transmission method over the radio path to the connecting device and the system comprises means for further transmitting pictures that have been re-processed as required by the transmission method, if necessary, over the radio path to at least one user terminal.

23. A video surveillance system which comprises a video camera system, a connecting device and at least one user terminal, the system comprising
means for transmitting commands concerning at least one video camera of the video system over the radio path from the user terminal to the connecting device and the system comprises means for further transmitting the commands over the radio path to at least one video camera of the video system,
means for taking a pre-determined number of pictures at pre-determined intervals,
means for transmitting pictures processed as required by the transmission method over the radio path to the connecting device and the system comprises means for further transmitting pictures that have been re-processed as required by the transmission method, if necessary, over the radio path to the user terminal.

24. A video surveillance system according to claim 22, the system further comprising means for transmitting commands over the radio path from the user terminal to at least one video camera of the video system.

25. A video surveillance system according to claim 22, wherein at least one video camera starts videoing at the command of the detector or the surveillance arrangement.

26. A video surveillance system according to claim 22, wherein the connecting device is a wireless modem.

27. A video surveillance system according to claim 21, wherein the detector is a motion detector.

28. A video surveillance system according to claim 21, wherein an alarm is given by a sound signal in the user terminal or at the location under surveillance.

29. A video surveillance system according to claim 21, wherein an alarm is given by a sound signal in the user terminal and at the location under surveillance.

30. A video surveillance system according to claim 21, wherein the alarm message is a picture message (MMS).

31. A video surveillance system according to claim 21, wherein the alarm message is a textual message.

32. A video surveillance system according to claim 21, wherein the alarm message is a voice message.

33. A video surveillance system according to claim 23, wherein the user terminal is a terminal provided with a wireless Internet connection.

34. A video surveillance system according to claim 23, wherein the user terminal is a videophone.

35. A video surveillance system according to claim 23, wherein the pictures to be transmitted are still pictures.

36. A video surveillance system according to claim 23, wherein the pictures to be transmitted are moving pictures.

37. A video surveillance system according to claim 23, wherein sound is transmitted in addition to the pictures.

38. A video surveillance system according to claim 22, wherein the notification by the surveillance arrangement is transmitted as a picture message (MMS).

39. A video surveillance system according to claim 22, wherein the notification by the surveillance arrangement is transmitted as a textual message.

40. A video surveillance system according to claim 22, wherein the notification by the surveillance arrangement is transmitted as a voice message.

41. A video surveillance system according to claim 23, wherein the commands concerning the video camera include the following information: password, command or property to be changed.

42. A video surveillance system according to claim 23, wherein the commands concerning the video camera include the following information: password, command and property to be changed.

43. A camera application module of a video surveillance system, the module comprising
means for receiving commands transmitted from the user terminal via the connecting device,
means for receiving a start signal transmitted from the detector or the surveillance arrangement,
means for controlling the camera according to the commands or the start signal,
means for transmitting messages and/or pictures via the connecting device to the user terminal.

44. A camera application module according to claim 43, wherein the pictures to be transmitted are still pictures.

45. A camera application module according to claim 43, wherein the pictures to be transmitted are moving pictures.

46. A camera application module according to claim 43, wherein sound is transmitted in addition to the pictures.

47. A camera application module according to claim 43, wherein the commands concerning the video camera include the following information: password, command and/or property to be changed.

48. A camera application module according to claim 43, wherein the camera application module is integrated into the video camera.

49. A camera application module according to claim 43, wherein the camera application module is separate from the video camera and fixed to the video camera or connected to. it over a radio connection.
